(19) United States
(12) Patent Application Publication
(10) Pub. No.: US 2006/0061107 A1
(43) Pub. Date: Mar. 23, 2006

(54) Energy scavenging methods and apparatus

(76) Inventor: Paul Cadaret, Trabuco Canyon, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/088,647

(22) Filed: Mar. 23, 2005

Related U.S. Application Data
(60) Provisional application No. 60/556,151, filed on Mar. 24, 2004.

(51) Int. Cl. F03D 9/00

(52) U.S. Cl. 290/44

(57) ABSTRACT

Methods and devices for efficiently extracting long-term energy from the external environment or the propulsion system of a vehicle in motion or operation are described. The vehicle can be in the form of a missile, aircraft, sensor-pod, Space Shuttle, ship, submarine, propeller, or other moving body. Methods and devices are also described to generate short-term power during initial usage operations when power generation is needed but the vehicle is not yet sufficiently moving to make external energy extraction viable.

This application claims priority to provisional application No. 60/556,151 filed Mar. 24, 2004.

### FIELD OF THE INVENTION

The field of the invention is transportation.

### BACKGROUND

Currently, power generation on a missile, airplane, ship or other moving vehicle is accomplished by an internal power plant, whether a motor powered generator or alternator, battery or other source. Such generation, however, is often inefficient. Inefficiencies are especially pronounced when the vehicle has excess kinetic energy as in the case of a missile or airplane reducing altitude, or a ship or automobile reducing speed.

In automobiles, many systems have been proposed for producing electrical power from the braking function, by applying a generator as a brake. The energy can then be stored in batteries as opposed to being lost to the atmosphere as heat from bake shoes and rotors.

It is also known to derive energy from a rotating turbine mounted on a ship. Such devices have been used instead of or in addition to wind sails, but have never gained commercial acceptance.

What has not been appreciated, however, is that energy can also be derived from the fluid through which the vehicle is traveling; whether air as in the case of an aircraft (e.g. missile, airplane, or jet) or land craft (e.g. train, truck or automobile), or water as in the case of watercraft (e.g., ship, submarine, or torpedo). Thus, a need currently exists that would derive electrical or other power from movement of air or water past a moving vehicle.

A case in point here is missile electrical power generating applications. The missile design community has relied on the use of internal thermal batteries for many years to provide electrical power for missile systems. Such batteries are low in power output, short in operating lifespan, and are one-time use devices. Recent US government research topics indicate that the government is now seeking alternative electrical power generation options that can provide more electrical power for extended periods of time and in a reusable manner. Another case for the need for scavenged power is in the area of instrumentation power in environments where the transmission of electrical power via wires is problematic. Recent US government research topics indicate that the government is now seeking methods to provide power to instruments located on rotating propulsion components such as propeller blades. These published US government needs have motivated the development efforts that resulted in the methods and apparatus described in this patent application.

### SUMMARY OF THE INVENTION

The present invention provides apparatus, systems and methods in which an energy recovery system captures material from a fluid of an environment through which a vehicle is traveling, converts kinetic energy in the fluid (relative to the vehicle) to the vehicle, and transfers the produced energy to at least partially operate at least some aspect of the vehicle.

In preferred embodiments the energy converter is a turbine internal to the vehicle, which produces electrical energy. In addition, preferred embodiments use at least one inlet door or other flow controller to control the flow of fluid through the turbine. One or more batteries can also be included to store at least some of the produced energy.

Contemplated inventive vehicles include an energy converter internal to the vehicle that produces at least one of electrical and mechanical energy from a difference in velocity between the vehicle and a supporting fluid through which the vehicle is traveling. Contemplated vehicles include a missile or other aircraft, and a torpedo or other watercraft.

Contemplated methods include: providing an energy converter on-board a device, the energy converter carrying the device through a medium at a speed sufficient to produce energy from the energy converter; and using the energy to operate the device while the device is still being carried.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1a is a schematic of a preferred energy harvesting apparatus that can be used to extract mechanical energy from the environment surrounding a moving vehicle for the purpose of electrical power generation. The schematic shows the energy harvesting apparatus in an operational or deployed state.

FIG. 1b is a schematic of a preferred energy harvesting apparatus that can be used to extract mechanical energy from the environment surrounding a moving vehicle for the purpose of electrical power generation. The schematic shows the energy harvesting apparatus in a non-operational or non-deployed state.

FIG. 2 is a schematic of a preferred energy harvesting apparatus as might be used within the body of an aircraft mounted missile or and aircraft mounted sensor pod. The schematic shows the energy harvesting apparatus in an operational or deployed state.

FIG. 3 is a schematic of a preferred energy harvesting apparatus as might be used within the body of a land-based canister-deployed missile. The schematic detail view shows the details of a short-term power source for initial power generation as would be needed during missile launch.

FIG. 4 is a schematic of a preferred energy harvesting apparatus that is similar to FIG. 1a except that the vehicle power generated is hydraulic or pneumatic in nature.

FIG. 5 is a schematic of a preferred energy harvesting apparatus that can be variably deployed to generate power by harvesting energy from moving fluid stream external to a vehicle in operation.

FIG. 6 is a schematic of a preferred energy harvesting apparatus that utilizes one or more Piezo-electric elements and a variable turbulence generating protrusion to harvest energy from be moving fluid stream external to a vehicle in operation.

FIG. 7 is a schematic of a preferred energy harvesting apparatus that utilizes materials that collect or shed electrons when they come in contact with a moving fluid stream.

FIG. 8 is a schematic of a preferred energy harvesting apparatus as might be used to provide electrical power for an instrument pod mounted to the exterior surface of a ship or submarine. This example utilizes an internal turbine mechanism to harvest energy and generate power.

FIG. 9 is a schematic of a preferred energy harvesting apparatus as might be used to provide electrical power for an instrument pod mounted to the exterior surface of a ship or submarine. This example utilizes external Piezo-electric elements to harvest energy and generate power.

FIG. 10 is a schematic of a preferred energy harvesting apparatus that captures a small portion of propellant from a rocket motor or other exhaust gas stream for the purpose of driving a turbine to generate electrical power.

FIG. 11 is a schematic of a preferred energy harvesting apparatus that captures a small portion of propellant from a rocket motor or other exhaust gas stream for the purpose of driving a turbine to generate hydraulic, pneumatic, or other mechanical power.

FIG. 12 is a schematic of a preferred energy harvesting apparatus that exploits the pressure differential environment between the two faces of a moving propeller blade to drive an embedded turbine to generate electrical, hydraulic, pneumatic, or other mechanical power. This energy harvesting apparatus utilizes a “flow through” approach.

FIG. 13 is a schematic of a preferred energy harvesting apparatus that exploits the rapid fluid flow across a moving propeller blade face to drive an embedded rotor to generate electrical, hydraulic, pneumatic, or other mechanical power. This energy harvesting apparatus utilizes a “flow by” approach.

FIG. 14 is a schematic of a preferred energy harvesting apparatus that exploits the rapid fluid flow across a moving propeller blade face to drive an embedded rotor to generate electrical, hydraulic, pneumatic, or other mechanical power. This energy harvesting apparatus also utilizes a “flow by” approach.

### DETAILED DESCRIPTION

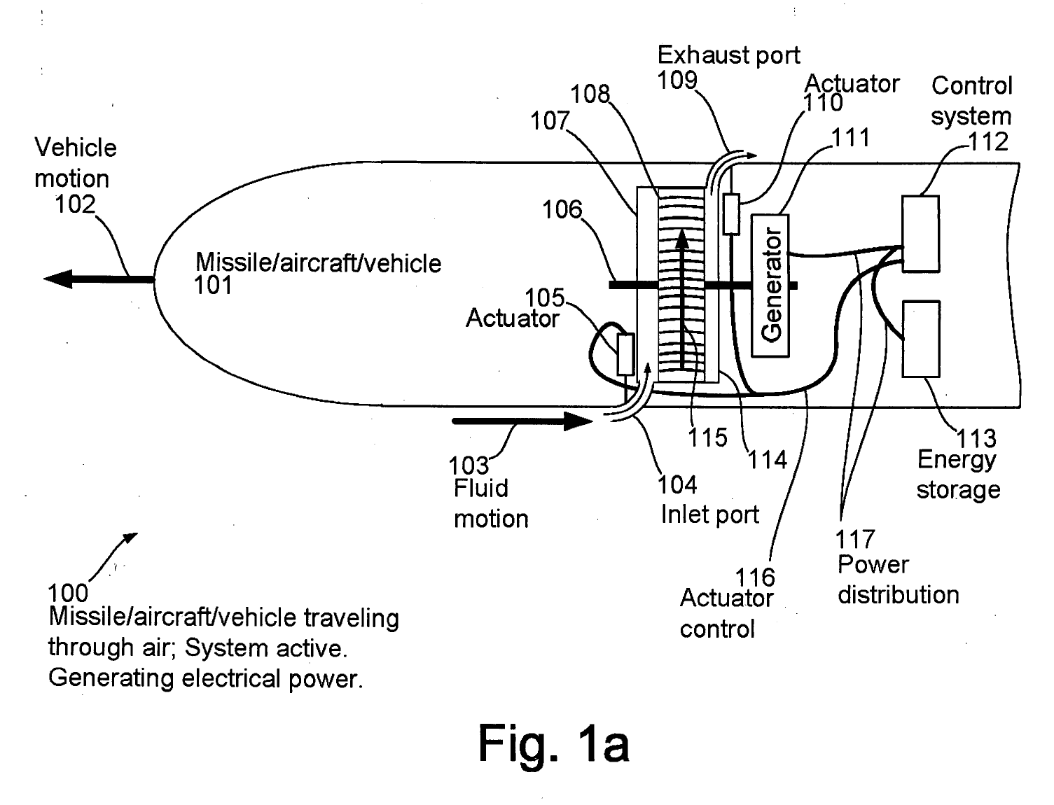

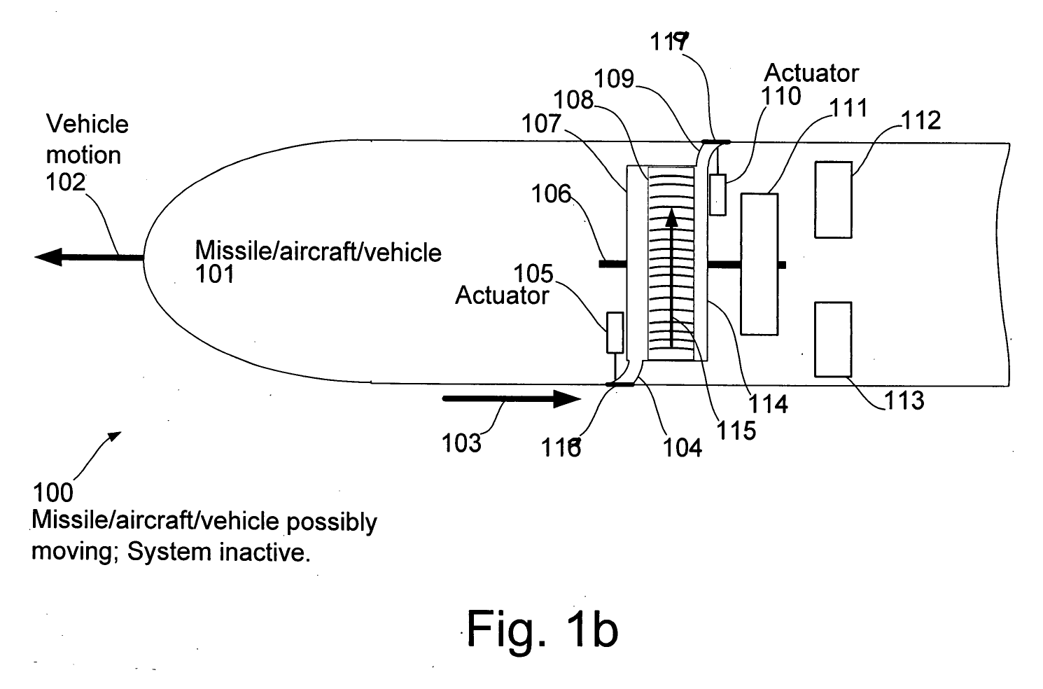

FIG. 1a generally depicts a vehicle body 101 that is in motion 102 through a surrounding airstream 103. A portion of the surrounding airstream is harvested or captured through a fixed, movable, or variable geometry inlet 104 that may be optionally under the control of an actuator 105 and directed toward the high-pressure side of a turbine cavity 107. Note that one or more inlets 104 and outlets 109 our envisioned in a preferred implementation. An internal turbine 108 that rotates around a shaft 106 then extracts energy from the high-pressure airstream as it flows toward the low-pressure turbine cavity 114 from which it is finally directed toward one or more exhaust ports 109 that may be fixed, movable, or variable geometry in nature. It should be noted that a preferred implementation can contain separate inlet port actuators 105 and exhaust port actuators 110. As the turbine assembly 108 rotates around the shaft 106 this rotational energy is then used to drive an electrical generator assembly 111. To provide for the efficient extraction and utilization of harvested environmental energy a preferred implementation would make use of a control system 112 to try to optimally utilize the energy generation components available in an implementation, and it would also include a battery or other energy storage device 113 for storage. When actuators are used, the control system 112 is connected to the actuators 105 and 110 via the cabling or other connectivity paths shown as 116. Connector 117 transfers at least some of the produced energy to (a) the energy storage device 113 and (b) a control system 112 to at least partially operate at least some aspect of the vehicle.

It should additionally be appreciated that the vehicle body 101 is shown here in a generic sense, such that the body 101 should be interpreted as being any aircraft, land craft or watercraft. It should be especially appreciated that vehicle body 101 can correspond to a military ordinance or other military vehicle. Similarly, the turbine 108 could be implemented adjacent to or otherwise outside the body 101, and indeed turbine 108 should be interpreted here in a generic sense to represent any suitable energy converter that produces at least one of electrical and mechanical energy from kinetic energy in the ambient fluid (air or water) relative to the vehicle

As used herein, the ambient atmosphere is the environment of the body 101, and the fluid through which the vehicle is traveling is the airstream 103. Where the body 101 corresponds to an aircraft in flight, the airstream also comprises a supporting fluid because it is the airstream that maintains the aircraft in flight. When the aircraft is parked on the ground, airstream 103 can still comprise a fluid from which kinetic energy is extracted, but would no longer comprise a supporting fluid because the support for the aircraft is the ground. As another example, a surface boat has two fluids in its environment, air and water, and either or both could be used to extract energy. In that case, however, the water is a supporting fluid and the air is not a supporting fluid.

FIG. 1b generally depicts the vehicle 101 of FIG. 1a, except that here the energy harvesting components are in an inactive or non-operational state. Of particular interest is that the airflow inlets 104 and outlets 109 can be closed and may be sealed by movable doors 118, 119, respectively. As used herein, the term “door” is used generically to include any orifice adjusting mechanism, including for example an iris or a sliding cover.

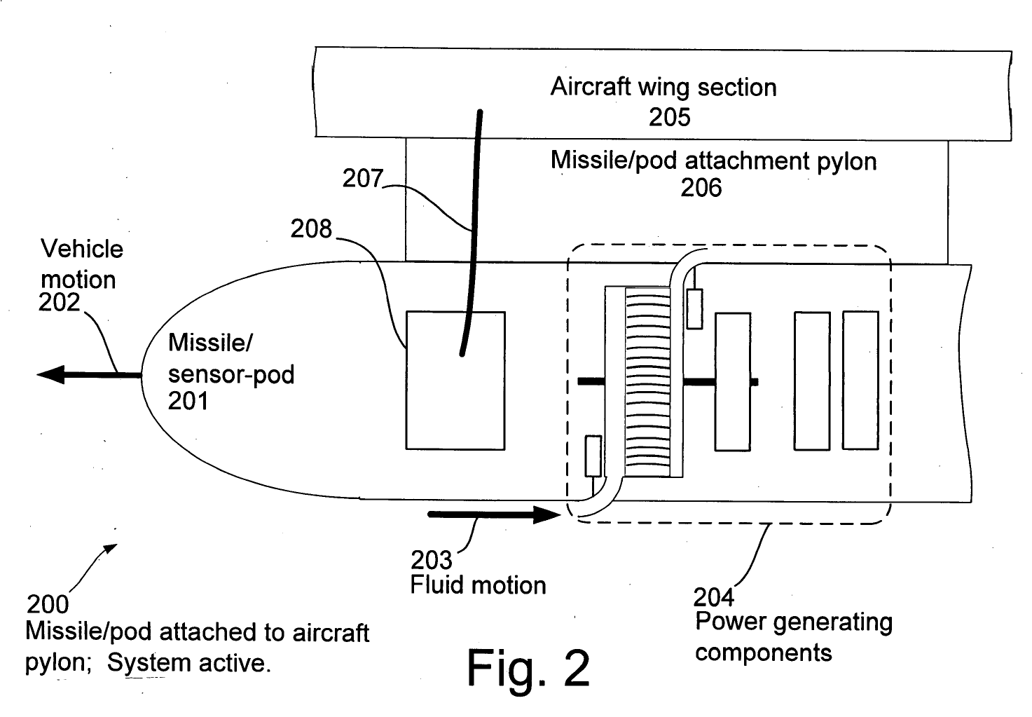

FIG. 2 generally depicts an aircraft wing-mounted missile or sensor-pod 200. A pylon 206 is shown as an attachment point for the aircraft wing 205 and the missile or sensor pod 201 is shown attached to the pylon. The aircraft and all components are shown in motion 202 through the air. The power generating components shown 204 are similar to FIG. 1a. Since a missile or a sensor pod can start off in a non-deployed or inactive power harvesting state, FIG. 2 also shows a communication and minimal power connection 207 from the aircraft 205 to a local missile or sensor-pod control system 208. The purpose of this link is to provide minimal power to the control system and local energy harvesting actuators as well as to provide a communication link through which the aircraft can inform the control system 208 when to activate the local energy harvesting and power generation system components. Those skilled in the art will appreciate that the specific embodiment of FIG. 2 can be readily generalized to any air-launch system.

A point of significant interest is that modern missiles, and possibly some other military vehicles, rely on thermal batteries for electrical power. Thermal batteries provide relatively low power output for short durations and are one-time use devices. The power generation method described allows for extended testing of missile components such as seeker systems while on the aircraft wing during a flight. This provides the aircraft pilot with significant advance notice regarding the health status of the weapons being carried.

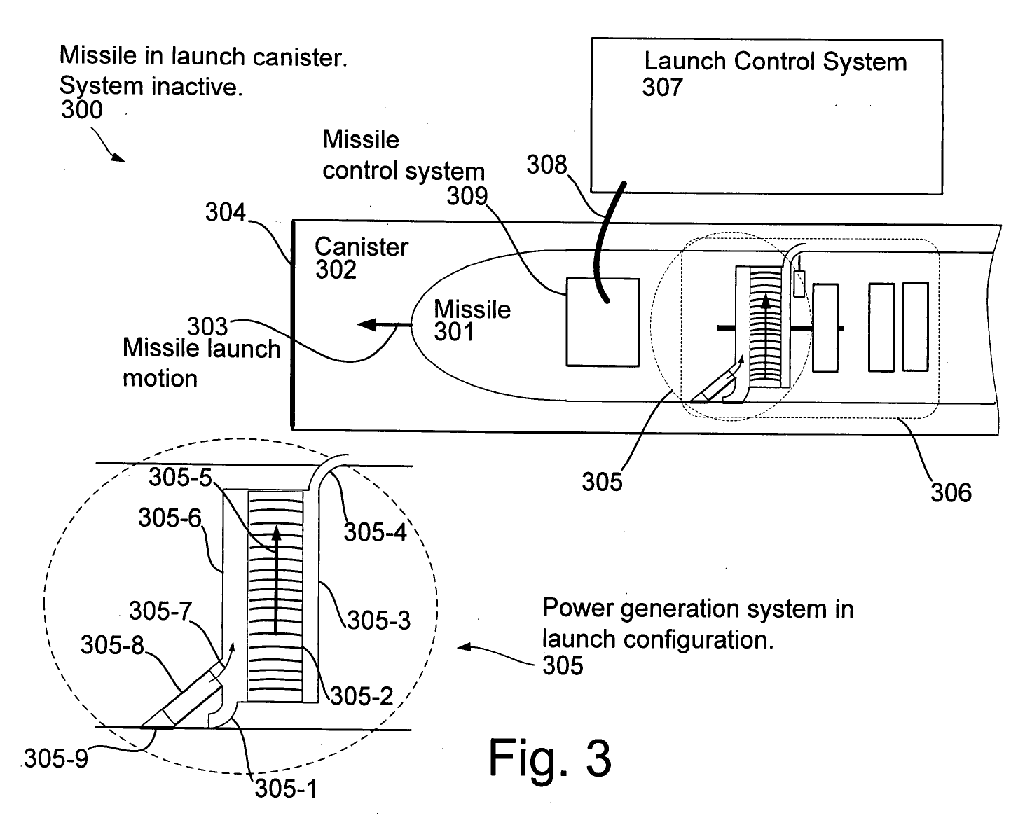

FIG. 3 generally depicts a ground or ship launched missile system where a missile is transported and launched from an enclosing canister 300. In the diagram shown the missile 301 is shown within a canister 302 that will begin motion at launch in the direction shown 303 and will exit the canister through the opening shown as 304. To avoid the need for batteries within the missile the control system within the missile 309 would be provided with minimal initial power from the external launch control system 307 via the cabling 308. The would also provide for communication between the launch control system 307 and the missile control system 309.

A point of significant interest in this example is that the power generation components shown as 306 have no external energy to harvest at initial missile launch time. In this example the detail view 305 shows that the power generating components are largely the same as that shown in FIG. 1 except that a slight modification is shown whereby a substantial amount of power can be generated by the turbine components while the missile is still within the canister. The primary modification in this preferred embodiment example is the addition of a small solid rocket motor or compressed gas canister 305-8 that can be triggered to release a substantial stream of compressed gas to drive the turbine for several seconds at missile launch time. The detail view shown in 305 includes a door 305-9 that can be used to insert a replaceable small solid rocket motor or compressed gas canister 305-8. When this small motor is triggered or the gas canister is released a substantial stream of compressed gas 305-7 is then available within the high-pressure side of the turbine cavity 305-6 to drive the turbine 305-2 in the direction shown 305-5. Of particular interest here is that it is important that the movable or variable geometry inlet port 305-1 is closed so that the compressed stream of gas within the cavity 305-6 must pass through the turbine 305-2. Consistent with earlier figures the exhaust gas stream is collected in the low-pressure turbine cavity 305-3 and is ultimately released through the exhaust port 305-4. In this operational scenario it is important that the exhaust port 3054 not be closed.

Another point of significant interest is that compared to ground-launched missile systems that rely on thermal batteries, the power generation system shown is testable. The described preferred apparatus utilizing a replaceable small solid rocket motor or gas canister means that a ground based missile can be periodically tested as a complete system to assure that all components are functioning properly.

Those skilled in the art will appreciate that the specific embodiment of FIG. 3 can be readily generalized to any ground or ship launch configuration.

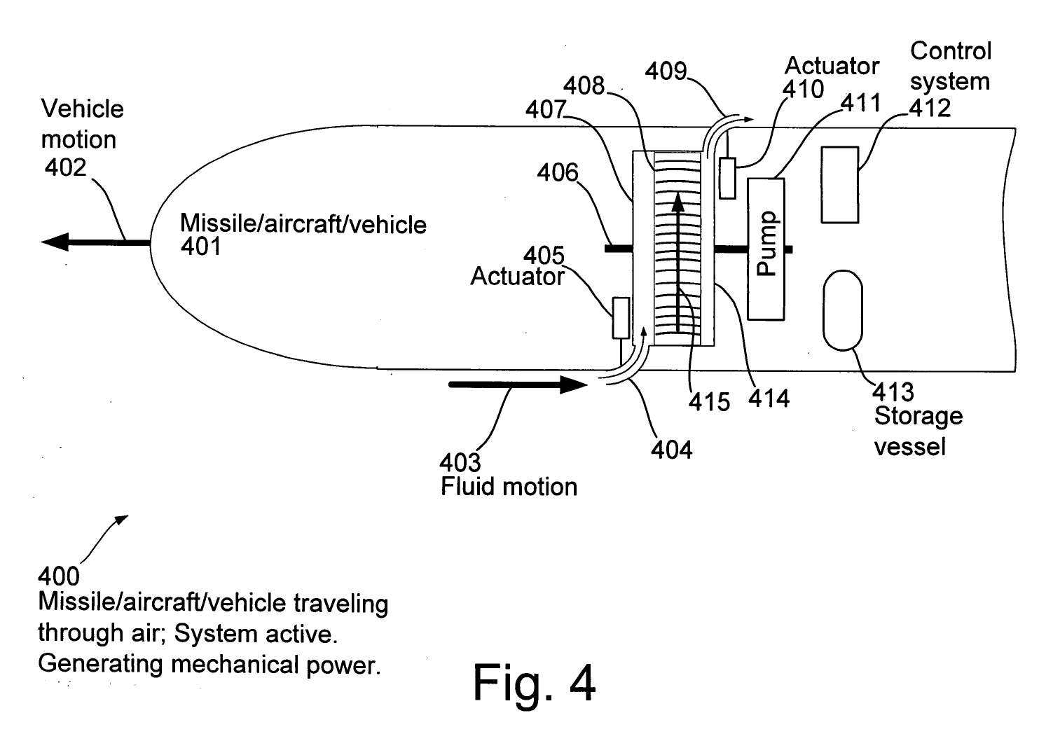

FIG. 4 is again similar to FIG. 1a except that mechanical power is being generated 400. The primary point of deviation from FIG. 1a is the fact that a mechanical pump 411 is the primary energy generating mechanism shown. Similar to FIG. 1a a control system 412 is used to efficiently harvest energy from the surrounding environment. In this preferred embodiment a storage vessel 413 is used as an energy storage device to meet the needs of the vehicle.

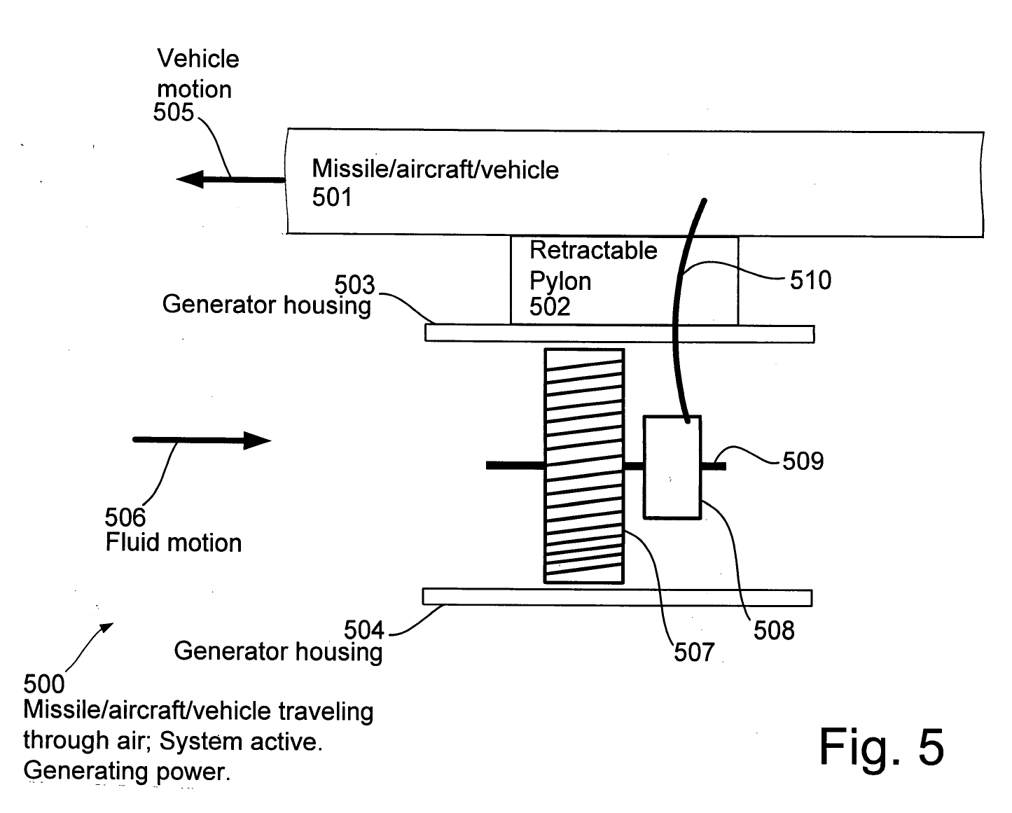

FIG. 5 generally depicts a preferred energy harvesting mechanism where a retractable energy-harvesting device can be directly inserted within the vehicle's external environment to harvest energy 500. The vehicle and all components shown would be moving in the direction shown 505 and this would result in an external air or water flow as shown in 506. This preferred embodiment of the invention provides the most direct and efficient form of energy harvesting and in his envisioned to be used when a substantial amount of energy harvesting is required. To maintain high operational efficiency a preferred implementation would provide for a retractable pylon 502 and generator assembly whereby the amount of energy harvested from the external fluid flow 506 can be controlled. Additionally, a preferred implementation might also include variable pitch turbine blades 507 to allow for precise control of the amount of energy harvested from the environment. The turbine assembly 507 would be coupled via a shaft 509 to a generator or pump 508 to generate electrical or various mechanical forms of energy as needed by the vehicle 501. Such generated energy can be provided to the vehicle 501 via the electrical, hydraulic, or pneumatic line shown 510.

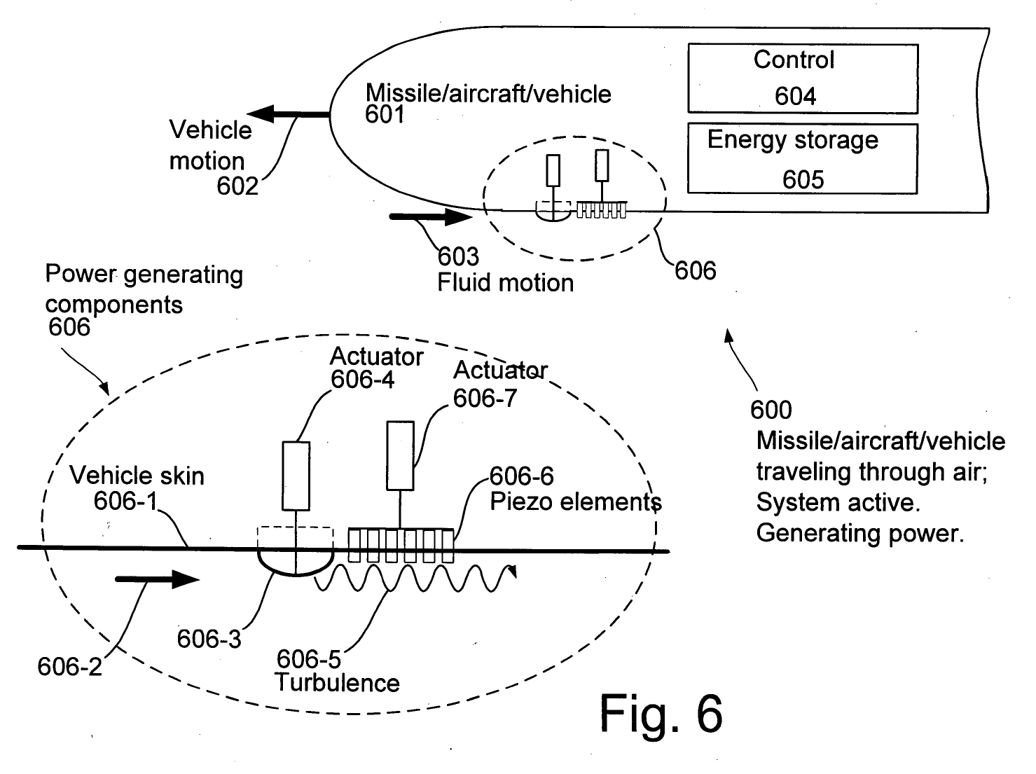

FIG. 6 generally depicts a missile, aircraft, or other vehicle traveling through the air and capable of generating electrical power as shown 600. The motion of the vehicle 601 in the direction shown as 602 through the air stream results in a relative motion of the surrounding air stream relative to the vehicle as shown in 603. As the air stream passes by the components shown in 606 electrical power can be generated. The detail view of the components shown as 606 provides more detail as to the operation of the power generating components. In this view the vehicle's external air stream 606-2 is shown passing parallel to the skin of the vehicle 606-1. As the external air stream 606-2 comes in contact with a fixed or movable protrusion 606-3 that may be under the control of the actuator 606-4 airflow turbulence 606-5 is generated following the movable protrusion. The energy contained within the turbulence is then harvested via one or more piezoelectric elements 606-6 which themselves can be movable for optimally efficient energy collection under the control of an actuator shown as 606-7. Control of the actuators in a preferred implementation would be controlled by a control system 604 and the energy collected would be stored in an energy storage device 605 and distributed to various vehicle systems.

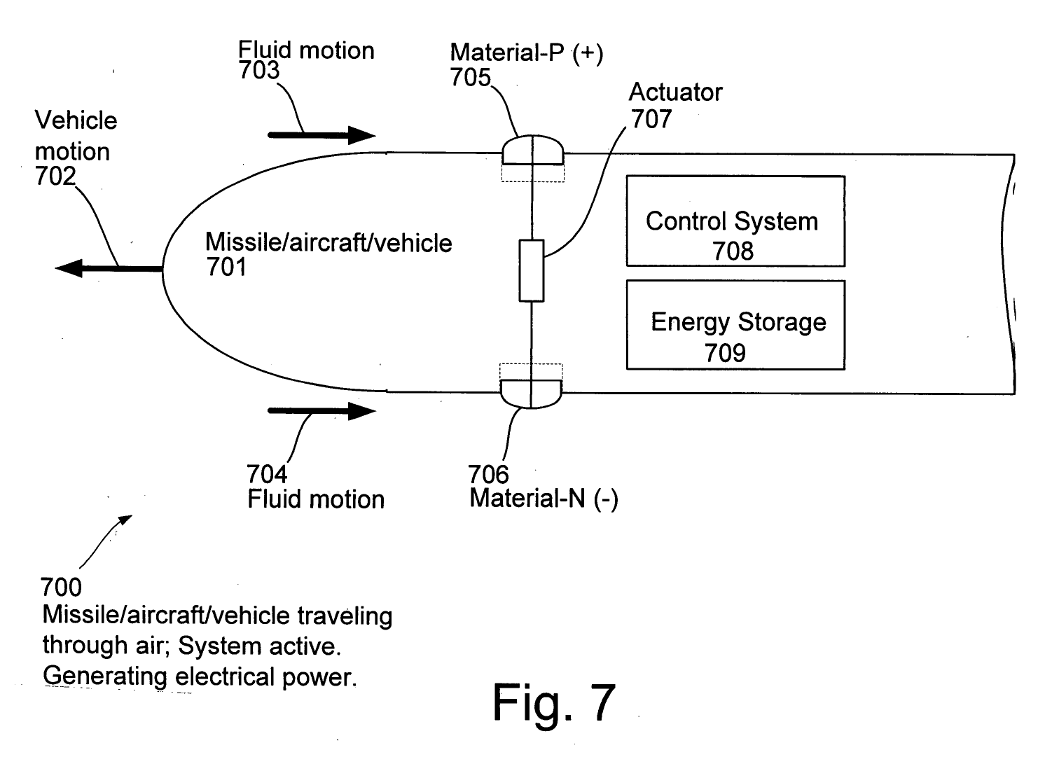

FIG. 7 generally depicts a missile, aircraft, or other vehicle traveling through the air and capable of generating electrical power as shown 700. The motion of the vehicle 701 in the direction shown as 702 through the air or other fluid stream results in a relative motion of the surrounding fluid stream relative to the vehicle as shown in 703 and 704. As the air stream passes by the components shown as 705 and 706 a continuous electrical charge is produced. The material-P 705 is shown as a material that sheds electrons when exposed to friction with the external air stream. The material-N 705 is shown as a material that collects electrons when exposed to friction with the external air stream. By harvesting the electrical charge that is produced by material-P and material-N a continuous electrical energy source is made available. A preferred optimal implementation would utilize a control system 708 to control one or more possible actuators 707 that would in turn be used to control the extent to which the energy collection elements 705 and 706 are exposed to the surrounding vehicle air stream. A preferred implementation would also transfer the electrical energy collected to an energy storage device 709 prior to conversion and distribution to other vehicle systems.

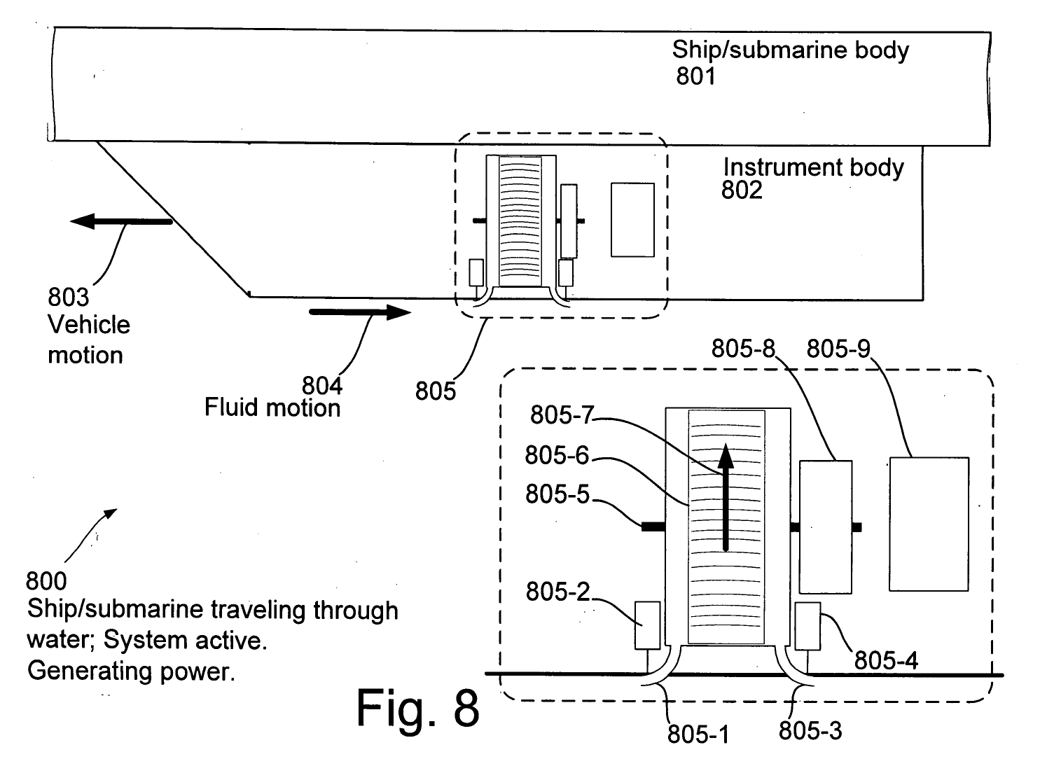

FIG. 8 generally depicts a ship, submarine, torpedo, or other vehicle traveling through the water and capable of generating electrical power as shown 800. The motion of the vehicle 801 in the direction shown as 803 through the water or other fluid stream results in a relative motion of the surrounding fluid stream relative to the vehicle as shown in 804. The power generating components are shown as 805. The detail view shown as 805 shows power generating components that are largely similar to that shown in FIG. 1a but are used to harvest energy from a moving water stream. The detail view shows a fixed, movable, or variable geometry inlet 805-1 that is possibly under the control of an actuator 805-2 directing the external water flow into the high-pressure side of a cavity to drive a turbine 805-6 in the direction shown as 805-7. The water flows through the turbine toward the low-pressure side of the cavity and is then vented through a fixed, movable, or variable geometry exhaust port 805-3 that may in turn be controlled by an actuator 805-4. The rotational energy collected is then used to drive an electrical generator, pump, or other energy generation device 805-8. A preferred implementation would utilize a control and energy storage system 805-9 to intelligently control the energy harvesting and distribution process.

An advantage of the energy harvesting system according to FIG. 8 is that the instrument body shown as 802 can be self sufficient from an energy perspective and need not rely upon power supplied from the body of the attached vehicle 801. This can be very useful in that it eliminates the need for hull penetrations for various types of externally mounted instruments.

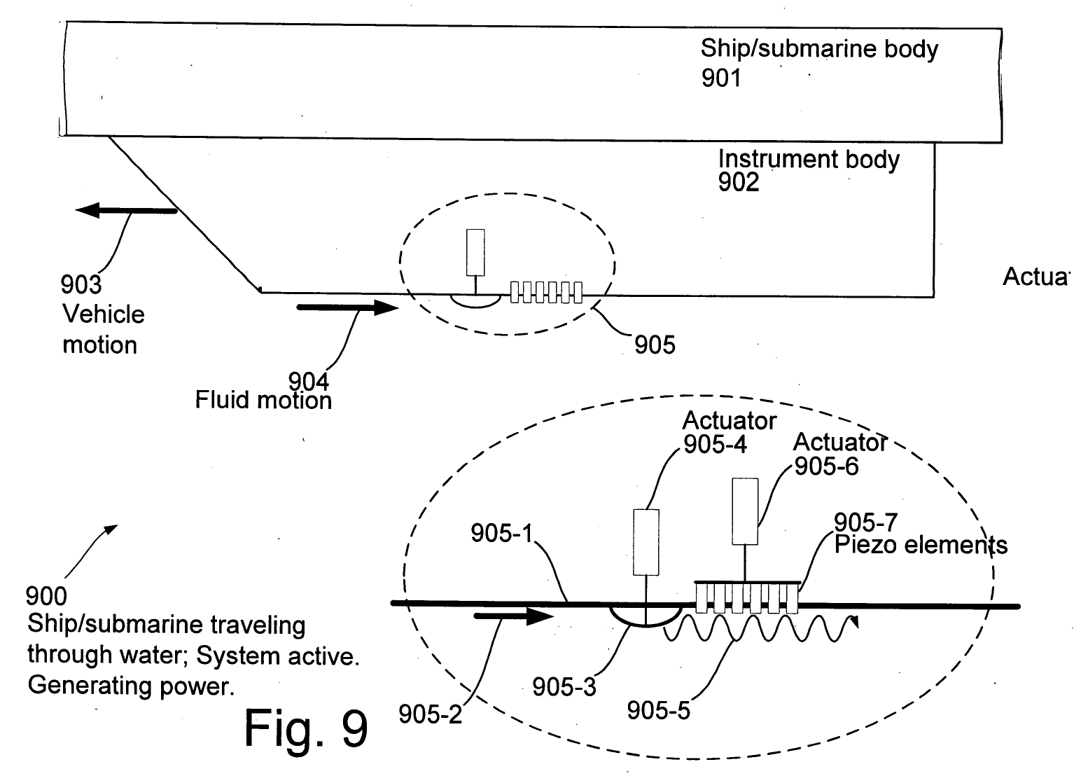

FIG. 9 generally depicts a ship, submarine, torpedo, or other vehicle traveling through the water and capable of generating electrical power as shown 900. The motion of the vehicle 901 in the direction shown as 903 through the water or other fluid stream results in a relative motion of the surrounding fluid stream relative to the vehicle as shown in 904. The electrical power generating components are shown as 905. The detail view shown as 905 shows power generating components that are largely similar to that shown in FIG. 6 but are used to harvest energy from a moving water stream. The detail view shows the external water stream 905-2 moving parallel to the vehicle skin 905-1 coming in contact with a fixed or movable protrusion 905-3 that may be under the control of an actuator 905-4 and creating a zone of turbulence 905-5 behind the protrusion. Within the zone of the protrusion are located one or more piezo-electric devices 905-7 that can harvest the energy within the turbulence. A preferred implementation would have the piezo-electric devices 905-7 mounted in a movable way under the control of an actuator 905-6 to support optimal energy harvesting under a variety of conditions.

An advantage of the energy harvesting system according to FIG. 9 is that the instrument body shown as 902 can be self sufficient from an energy perspective and need not rely upon power provided by the body of the attached a vehicle 901. This can be very useful in that it eliminates the need for hull penetrations for various types of externally mounted instruments. A possible advantage of this implementation is that no rotating parts are present that are subject to biological fowling, therefore a longer service life is possible.

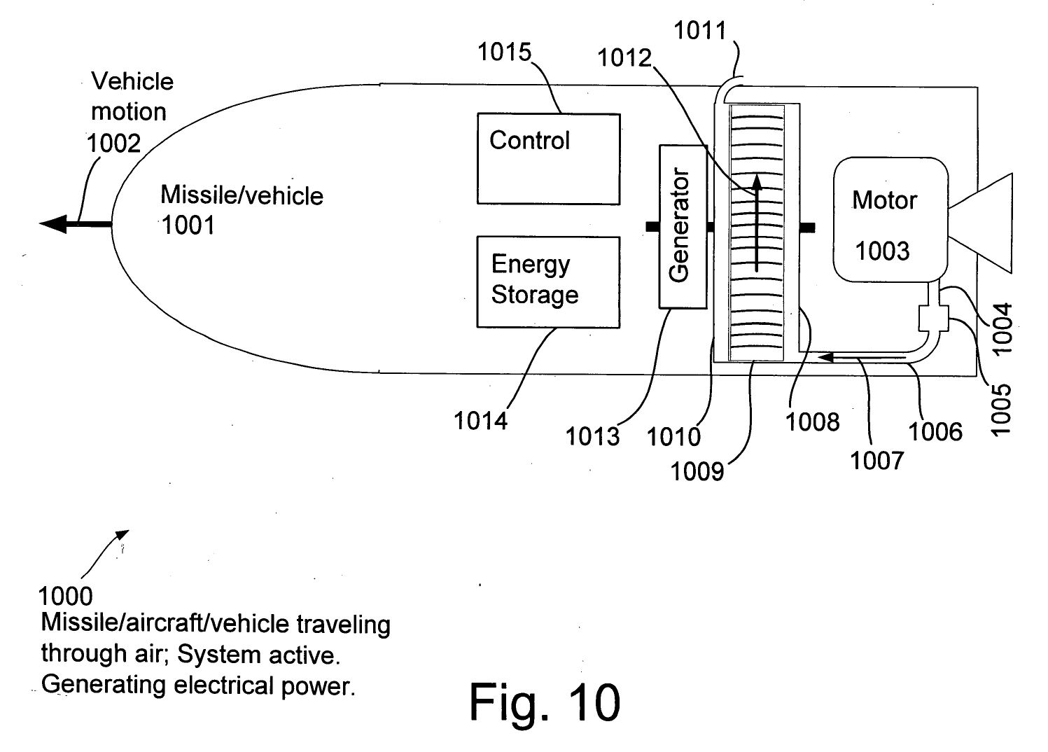

FIG. 10 generally depicts a missile, aircraft, Space Shuttle, or other vehicle traveling through the air and capable of generating electrical power as shown 1000. This figure focuses on harvesting a controlled amount of energy from the motor or other propulsion system 1003 of the vehicle. In this case the propulsion system depicted is a rocket motor that generates a compressed gas stream. A portion of the exhaust gas stream from the motor 1003 is directed through a port 1004 toward a controllable valve 1005. As the vehicle 1001 needs electrical energy, the control system 1015 would direct the valve 1005 to release some portion of the exhaust gas stream via the duct 1006 in the direction shown by 1007 toward the high-pressure side of the turbine cavity 1008 to drive the turbine assembly 1009 in the direction shown 1012. As the compressed gas passes by the turbine it enters the low-pressure side of the turbine cavity 1010 and ultimately passes out the exhaust port 1011. The rotational energy that is harvested by the turbine 1009 would be used to drive an electrical generator 1013 to provide electrical power for the vehicle. A preferred implementation would utilize a control system 1015 to harvest only a minimal amount of energy as needed and would also utilize an electrical energy storage device 1014 to provide for the instantaneous electrical power needs of the vehicle.

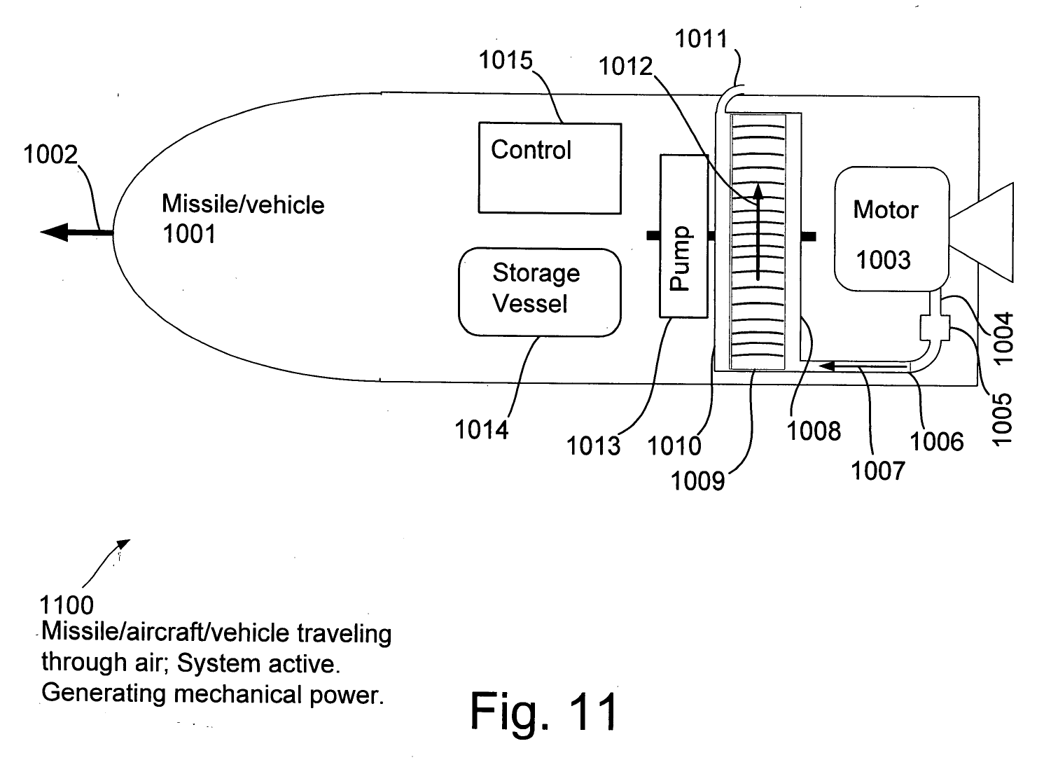

FIG. 11 generally depicts a missile, aircraft, space shuttle, or other vehicle whose exhaust gas stream can be efficiently and practically harvested to provide mechanical power for various vehicle systems 1100. The preferred implementation shown largely consists of components similar to that in FIG. 10, however, some minor changes to the method and apparatus are present. In this example the turbine assembly 1009 rotating in the direction shown 1012 is used to turn a hydraulic or pneumatic pump assembly 1013. A preferred implementation would likely also contain a storage vessel 1014 as well.

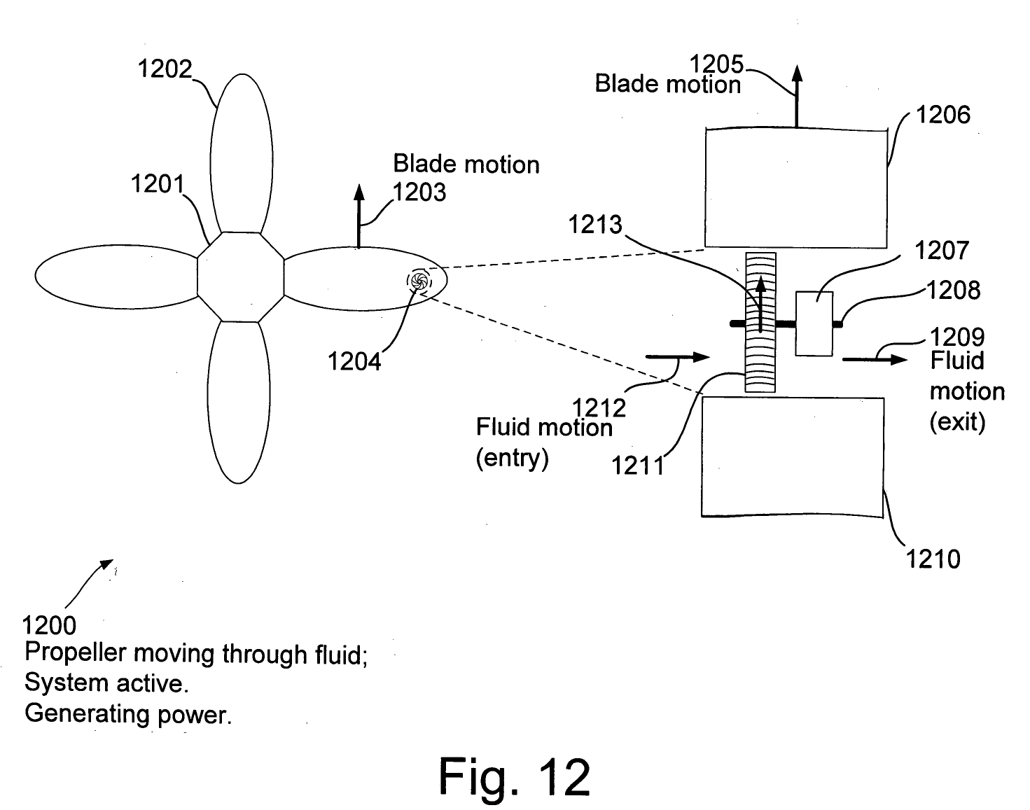

FIG. 12 generally depicts a propeller assembly for a ship, submarine, torpedo, or other vehicle that can benefit from the local generation of power within the rotating components of the rotating propulsion system components 1200. This preferred implementation exploits the pressure differential that is present between the two opposing faces of the propeller blade for the production of power. The depiction shows a propeller blade hub 1201 with four propeller blades exemplified by the top blade shown 1204 rotating in the direction shown as 1203. One area of the right side blade is shown to contain a small area for a power generation device 1204. The detail view to the right shows a cross sectional view of the body of the propeller blade as 1206 and 1210. In the detail view the high pressure side of the propeller face will cause the fluid to be driven from the point 1212 toward the point 1209 and in the directions shown. Within the small opening in the propeller blade 1204 is shown that a small turbine 1211 can be driven in the direction shown as 1213 that is coupled the a shaft 1208 to a electrical, hydraulic, pneumatic, or other power generator 1207 to meet any instrumentation needs locally within the rotating propeller assembly environment.

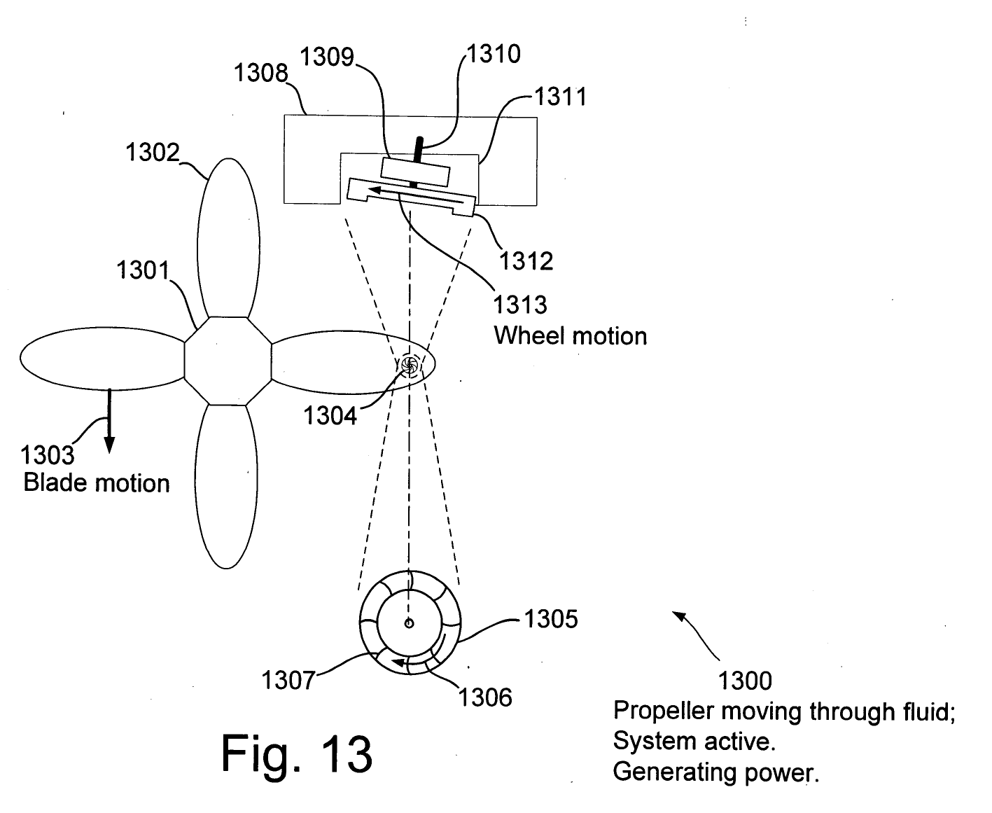

FIG. 13 generally depicts a propeller assembly for a ship, submarine, torpedo, or other vehicle that can benefit from the local generation of power within the rotating components of the rotating propulsion system components 1300. This preferred implementation exploits the water flow across the face of a propeller blade for the production of power. The depiction shows a propeller blade hub 1301 with four propeller blades exemplified by the top blade shown 1302 rotating in the direction shown as 1303. One area of the right side blade is shown to contain a small area for a power generation device 1304. The detail views below shows a preferred implantation for a possible modified turbine design in the form of a finned hub that can be used to generate power by harvesting the motion of the water that flows across the face of the turbine. In the lower detail view a round finned circular hub is shown as 1305, rotating in the direction shown as 1306, and an example protruding fin is shown as 1307. The detail view above shows a lengthwise cross section of the propeller blade as 1308 that contains a cavity within the propeller blade 1311 that contains a possibly offset fin hub 1305 for the harvesting of power that is in turn driving a shaft 1310 that in turn is used to drive a power generator 1309 of some form. One possible advantage of the preferred method and apparatus shown in 1300 is its likely tolerance to biofouling in a Marine environment.

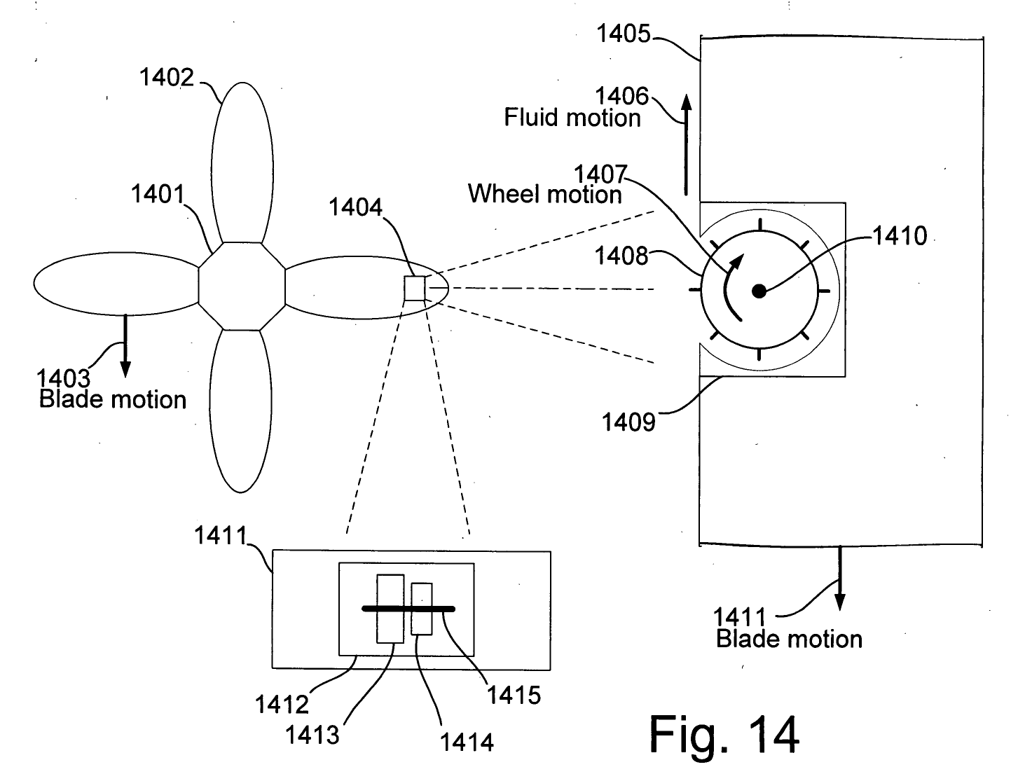

FIG. 14 generally depicts a propeller assembly for a ship, submarine, torpedo, or other vehicle that can benefit from the local generation of power within the rotating components of the rotating propulsion system components 1400. This preferred implementation exploits the water flow across the face of a propeller blade for the production of power. The depiction shows a propeller blade hub 1401 with four propeller blades exemplified by the top blade shown 1402 rotating in the direction shown as 1403. One area of the right side blade is shown to contain a small area for a power generation device 1404. The detail views below shows a preferred implantation for a possible modified turbine design in the form of a paddle-wheel that can be used to generate power by harvesting the motion of the water that flows across the face of the turbine. The lower detail view shows a propeller blade face view 1411 with a cut out cavity 1412 that contains a paddle-wheel energy harvesting device 1413 attached to a shaft 1415 that in turn drives a power generator 1414. The detail view to the right shows a cross sectional view of the propeller blade 1405 that contains a cut out for the power generation components 1409. The paddle-wheel energy harvesting device 1408 in this case is driven by the motion of the water across the face of the propeller blade 1406 and this causes the paddle-wheel to turn in the direction shown 1407. One possible advantage of this preferred method and apparatus as shown is that the paddle-wheel energy harvesting device can directly harvest energy in the direction of water motion and can efficiently generate a significant amount of power in a small space.

Thus, specific embodiments and applications of energy scavenging methods and apparatus have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced.

What is claimed is:

1. An energy recovery system for a moving vehicle comprising:
a first inlet that captures material from a fluid of an environment through which the vehicle is traveling;
a turbine that produces at least one of electrical and mechanical energy from kinetic energy in the material relative to the vehicle;
an outlet through which the material escapes back into the environment; and
a connector that transfers the produced energy to at least partially operate at least some aspect of the vehicle.

2. The system of claim 1, further comprising a first door that is operable to close the first inlet.

3. The system of claim 1, further comprising a second inlet that captures additional material that passes through the turbine.

4. The system of claim 3, further comprising first and second doors operable to open and close the first and second inlets, respectively.

5. The system of claim 4, further comprising a control system that seeks to operate the doors to optimize energy generation.

6. The system of claim 1, wherein the vehicle produces a propulsion stream, and the first inlet captures the material from the propulsion stream.

7. The system of claim 1, wherein the turbine produces electrical energy from kinetic energy in the material relative to the vehicle.

8. The system of claim 1, wherein the turbine produces mechanical energy from kinetic energy in the material relative to the vehicle.

9. The system of claim 1, further comprising a battery that stores the electrical energy.

10. A vehicle having an energy recovery system, comprising:
an energy converter internal to the vehicle that produces at least one of electrical and mechanical energy from a difference in velocity between the vehicle and a supporting fluid through which the vehicle is traveling; and
an energy storage device that stores at least some of the produced energy.

11. The system of claim 10, wherein the vehicle comprises an aircraft.

12. The system of claim 11, wherein the aircraft comprises a missile.

13. The system of claim 10, wherein the vehicle comprises a watercraft.

14. The system of claim 11, wherein the aircraft comprises a torpedo.

15. The system of claim 11, wherein the aircraft comprises a military vehicle.

16. A method of testing a device, comprising:
providing an energy converter on-board the device, the energy converter
carrying the device through a medium at a speed sufficient to produce energy from the energy converter; and
using the energy to operate the device while the device is still being carried.

17. The system of claim 16, wherein the aircraft comprises a missile.
